(19) United States
(12) Patent Application Publication
(10) Pub. No.: US 2009/0193163 A1
(43) Pub. Date: Jul. 30, 2009

(54) System for connecting UPnP devices in a UPnP network

(75) Inventors: Pascal Justen, (US); Christoph Stevens, (US); Werner Liekens, (US); Jan Coppens, (US); Christele Bouchat, (US); Willem Acke, (US)

Correspondence Address: HARNESS, DICKEY & PIERCE, P.L.C., P.O. BOX 8910, RESTON, VA, 20195, US

(73) Assignee: ALCATEL-LUCENT

(21) Appl. No.: 12/314,646

(22) Filed: Dec. 15, 2008

(30) Foreign Application Priority Data
Dec. 20, 2007 (EP) 07291579.6

(51) Int. Cl. G06F 13/42; G06N 5/02

(52) U.S. Cl. 710/105; 706/47

(57) ABSTRACT

A system for connecting Universal Plug and Play UPnP devices in a UPnP network includes a generic UPnP control point for UPnP devices and, externalized to such UPnP control point, control logic of the devices.

### BACKGROUND

The invention relates to a system for connecting Universal Plug and Play UPnP devices in a UPnP network and a connection method implementable in such a system.

UPnP is a network protocol notably applying to home networks interconnecting a plurality of devices. It is service-centric, in other words devices are dedicated to offer services to the home network user.

Devices implementing UPnP services are controlled via a UPnP control point. Such a UPnP control point manages the state (newly advertised or leaving, hierarchy) of a service offered by a UPnP device, either according to a user demand (e.g. via a remote control), either autonomously via local management software (e.g. home quality of service management). In this last case, the services provided by such devices need to be organized in a specific order as a service can depend on a previous one. For example, an incoming phone call is presented as a caption on TV, and as the user picks up the phone the TV volume is muted.

Dedicated UPnP control points consist in a software intermixing specific rules and logic in order to manage UPnP services.

UPnP control points remain tightly coupled to the UPnP services they manage. Thus, in a known manner, when a new UPnP service is detected, an additional dedicated UPnP control point must be developed.

Such UPnP control points development consequently causes:
extra costs, notably in licensing third party software or in-house development of a new UPnP control point;
extra deployment effort, as for each UPnP control point, at least one software is installed, periodically upgraded and maintained;
memory use increase on the system hosting the various UPnP control points.

Moreover some applications are very specific or use ad interim (e.g. monitoring, troubleshooting assistance, device pre-configuration), and a user might not be interested in investing in many software.

### SUMMARY

The purpose of the invention is to resolve the problems of the prior art by proposing, in particular, a system for connecting UPnP devices in a UPnP network using a generic UPnP control point which can be used to control all UPnP devices, for any UPnP service known upfront or not.

For that purpose and according to a first aspect, the invention relates to a system for connecting Universal Plug and Play UPnP devices in a UPnP network, said system comprising a UPnP control point for generic UPnP devices and, externalized to such UPnP control point, control logic means of the device.

According to a second aspect, the invention relates to a connection method of UPnP devices in a UPnP network, wherein dedicated TR-069 control signals are translated towards device dedicated UPnP control signals, and remote control of a generic UPnP control point is achieved by said dedicated signals.

Other aspects and advantages will become apparent in the following description made with reference to the appended figures that represent the system for connecting UPnP devices according to respectively one embodiment of the invention.

### BRIEF DESCRIPTION OF THE DRAWINGS

FIG. 1 illustrates an Open Services Gateway initiative service platform according to an embodiment.

FIG. 2 illustrates an open services gateway initiative service platform according to another embodiment.

### DETAILED DESCRIPTION OF EXAMPLE EMBODIMENTS

In the present invention UPnP devices 1 are connected in a UPnP network. Instead of one control point for each device, the system comprises a generic UPnP control point 2 for several and preferably all UPnP devices 1 of the network.

The generic UPnP control point 2 only addresses any kind of UPnP devices 1 and services in the network and control logic means of the devices are externalized from the generic UPnP control point 2.

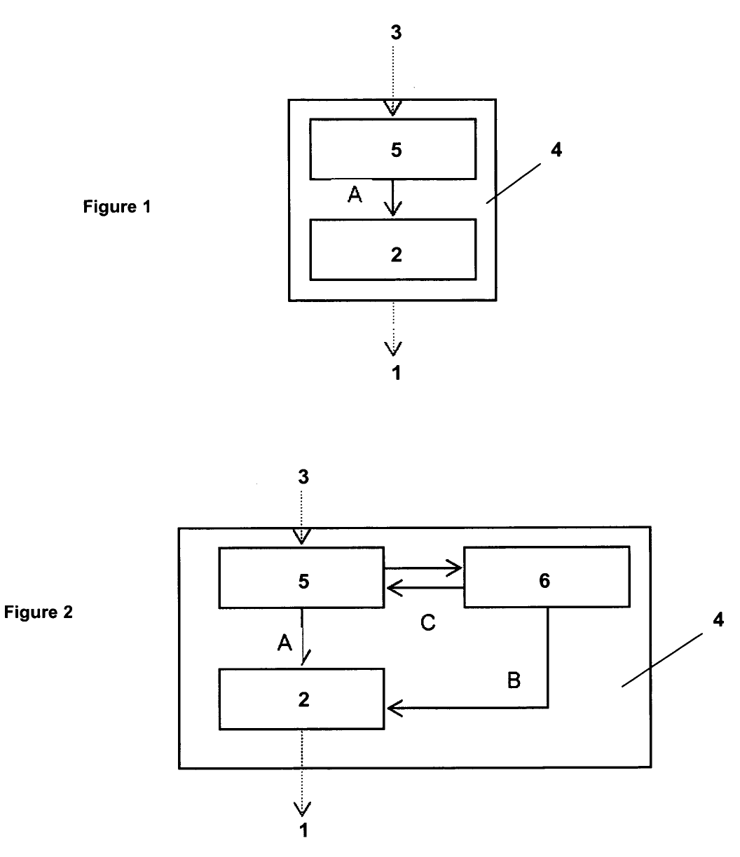

In a first embodiment, according to FIG. 1, the logic is fully delegated to the remote management server 3.

To do so, control logic means are implemented in the remote management server 3 of the network and the generic UPnP control point 2 is introduced in an Open Services Gateway initiative (OGSi) service platform 4 as an OSGi bundle.

The remote management server 3 submits commands to be executed by the generic UPnP control point 2, which is therefore interactively controlled through a remote management agent 5.

The remote management protocol used by the agent 5 is according to TR-069 standard.

Dedicated TR-069 control signals are translated towards device dedicated UPnP control signals, through an interface A.

The interface A is provided between the remote management agent 5 and the generic UPnP control point 2, said interface comprising means to control the creation of UPnP service control point, and means to report changes of UPnP devices state and of UPnP devices object hierarchy.

Dedicated TR-069 signals using the interface A retrieve the inventory of currently discovered UPnP devices 1 and services in the network. As new devices 1, and consequently new services, can regularly be added or removed from the network their quantity changes the same.

Because there is only one UPnP control point 2 the number of devices 1 and services needs to be referred. Though, TR-069 also receives notifications of state changes of UPnP devices 1 and services in the network. In order to optimize the UPnP devices management the generic UPnP control point 2 has to be kept aware of the newly advertised devices as well as the one removed from the network or changes in the device hierarchy.

Another function of the TR-069 signals is to invoke UPnP actions on UPnP services and ask to receive a notification when a UPnP state variable value changes. Device parameter and configuration audit can periodically be reported towards the remote management server 3, erroneous configuration parameters can be corrected.

Dedicated TR-069 signals allow then remote control of the generic UPnP control point achievement.

In one example, a user having trouble to make a UPnP device 1 work properly inside the home network can access the remote management server 3 and flag his devices 1 as not working, if the fault is not automatically detected. The server 3 is informed about the problem and instantiates a dedicated UPnP control point via the generic UPnP control point 2.

In a second embodiment of the invention, as shown in FIG. 2, the control logic means are implemented in the service platform 4 of the network, the generic UPnP control point 2 being driven by rule-based engine 6 on the OSGi service platform 4.

A remote management agent 5 of the remote management server 3 communicates network information to the generic UPnP control point 2, the same way as in the first embodiment. An interface A is provided between the remote management agent 5 and the generic UPnP control point 2, said interface comprising means to control the creation of UPnP service control point, and means to report changes of UPnP devices state and of UPnP devices object hierarchy.

The remote management agent 5 of the remote management server 3 submits UPnP devices managing rules to rule-based engine 6 on the OSGi service platform 4.

Such rules can be submitted for automating diagnostics, querying configuration data and measurement information that are collected.

The UPnP devices managing rules are dumped by the remote management agent 5, either by downloading a rule file at given URL (e.g. TR-069 DownloadReq RPC) or via a dedicated TR-069 object.

The rule-based engine 6 reports then requested data results to the remote management agent 5, which are further transmitted to the remote management server 3.

To assure the transmission of rules and data results, an interface C is provided between the remote management agent 5 and the rule-based engine 6.

In the other hand, generic UPnP control point 2 being driven by rule-based engine 6, an interface B is provided between them, said interface comprising means to formalize the application programming interface used by the rule-based engine 5 to discover UPnP devices 1, means to invoke UPnP actions and means to monitor changes in UPnP state variables.

1. System for connecting Universal Plug and Play UPnP devices in a UPnP network, said system comprising:
a generic UPnP control point for UPnP devices and, externalized to such UPnP control point, control logic of the devices.

2. System according to claim 1, wherein the control logic is implemented in remote management server of the network, the generic UPnP control point being interactively controlled through remote management agent.

3. System according to claim 2, wherein remote management protocol used by the agent is according to TR-069 standard.

4. System according to claim 2, wherein one interface is provided between the remote management agent and the generic UPnP control point, said interface comprising means to control the creation of UPnP service control point, and means to report changes of UPnP devices state and of UPnP devices object hierarchy.

5. System according to claim 3, wherein one interface is provided between the remote management agent and the generic UPnP control point, said interface comprising means to control the creation of UPnP service control point, and means to report changes of UPnP devices state and of UPnP devices object hierarchy.

6. System according to claim 1, wherein the generic UPnP control point is introduced on the Open Services Gateway initiative (OGSi) service platform as an OSGi bundle.

7. System according to claim 2, wherein the generic UPnP control point is introduced on the Open Services Gateway initiative (OGSi) service platform as an OSGi bundle.

8. System according to claim 3, wherein the generic UPnP control point is introduced on the Open Services Gateway initiative (OGSi) service platform as an OSGi bundle.

9. System according to claim 4, wherein the generic UPnP control point is introduced on the Open Services Gateway initiative (OGSi) service platform as an OSGi bundle.

10. System according to claim 1, wherein the control logic is implemented in the service platform of the network, the generic UPnP control point being driven by rule-based engine on the OSGi service platform.

11. System according to claim 10, wherein two interfaces are provided:
a first one between the remote management agent and the generic UPnP control point, said interface comprising means to control the creation of UPnP service control point, and means to report changes of UPnP devices state and of UPnP devices object hierarchy; and
a second one between said control point and rule-based engine, said interface comprising means to formalize the application programming interface used by the rule-based engine, means to invoke UPnP actions and means to monitor changes in UPnP state variables.

12. System according to claim 11, wherein a further interface is provided between remote management agent and rule-based engine, said interface comprising means to submit UPnP devices managing rules to the rule-based engine and means to report requested data results to the remote management agent.

13. Connection method of UPnP devices in a UPnP network, wherein dedicated TR-069 control signals are translated towards device dedicated UPnP control signals, and remote control of a generic UPnP control point is achieved by said dedicated signals.

14. Connection method according to claim 13, wherein dedicated TR-069 signals:
retrieve the inventory of currently discovered UPnP devices and services in the network;
receive notifications of state changes of UPnP devices and services in the network;
invoke UPnP actions on UPnP services and ask to receive a notification when an UPnP state variable value changes.

15. Connection method according to claim 13, wherein remote management agent submits UPnP devices managing rules to rule-based engine on the OSGi service platform, said engine reporting requested data results to the remote management agent.

16. Connection method according to claim 14, wherein remote management agent submits UPnP devices managing rules to rule-based engine on the OSGi service platform, said engine reporting requested data results to the remote management agent.

17. Connection method according to claim 15, wherein the UPnP devices managing rules are dumped by the remote management agent, either by downloading a rule file at given URL or via a dedicated TR-069 object.
